(19) United States
(12) Patent Application Publication
(10) Pub. No.: US 2014/0205763 A1
(43) Pub. Date: Jul. 24, 2014

(54) GROWTH OF GRAPHENE FILMS AND GRAPHENE PATTERNS

(71) Applicant: NUtech Ventures, Lincoln, NE (US)

(72) Inventors: Yongfeng Lu, Lincoln, NE (US); Wei Xiong, Lincoln, NE (US); Yunshen Zhou, Lincoln, NE (US)

(21) Appl. No.: 14/161,597

(22) Filed: Jan. 22, 2014

Related U.S. Application Data
(60) Provisional application No. 61/901,884, filed on Nov. 8, 2013.
(60) Provisional application No. 61/754,996, filed on Jan. 22, 2013.

(51) Int. Cl. C01B 31/04; H01B 13/00

(52) U.S. Cl. CPC C01B 31/0453; H01B 13/0026
USPC 427/530; 427/122; 427/557; 427/554

(57) ABSTRACT

Large area graphene can be fabricated by depositing carbon and catalytic metal thin film(s) on a substrate, heating the carbon and the catalytic metal, and forming graphene on the substrate. The catalytic metal is evaporated during the heating process. The catalytic metal can be, for example, nickel, cobalt, or iron.

### CROSS-REFERENCE TO RELATED APPLICATIONS

This application is claims priority to U.S. provisional application 61/754,996, filed on Jan. 22, 2013 and U.S. provisional application 61/901,884, filed on Nov. 8, 2013. The contents of the above applications are incorporated herein by reference in their entirety.

### TECHNICAL FIELD

This subject matter is generally related to the growth of graphene films and graphene patterns.

### BACKGROUND

Graphene has good electrical and optical properties, such as a high carrier mobility (15 000 cm²V⁻¹ s⁻¹) and a high transmittance for a wide range of wavelengths (e.g., from visible to near-infrared regions). In some examples, graphene films are fabricated on catalytic metal surfaces by use of chemical vapor deposition. Post-growth processes are used to etch the catalysts and transfer the graphene to dielectric substrates, such as SiO₂/Si, for further processing, such as adding components to form functional electronic devices. In some examples, graphene can be grown on dielectric substrates by pyrolytic decomposition of polymers on catalytic metal surfaces.

### SUMMARY

In general, in one aspect, a method for fabricating graphene is provided. The method includes depositing carbon and catalytic metal on a substrate; heating the carbon and the catalytic metal; and forming graphene on the substrate.

Implementations of the method may include one or more of the following features. Depositing carbon and catalytic metal on a substrate can include (1) depositing a layer of carbon on a substrate, and depositing a layer of catalytic metal on the layer of carbon, or (2) depositing a layer of catalytic metal on a substrate, and depositing a layer of carbon on the layer of catalytic metal. Depositing carbon and catalytic metal on a substrate can include co-depositing carbon and catalytic metal in a single layer on a substrate. The method can include evaporating the catalytic metal while heating the carbon and the catalytic metal. The catalytic metal can be, for example, nickel, cobalt, or iron. The layer of carbon can have a thickness in a range from about 1 nm to 100 nm. The layer of catalytic metal can have a thickness in a range from about 1 nm to 1000 nm. Forming graphene can include forming mono-layer, bi-layer, or multi-layer graphene on the substrate. Depositing carbon on a substrate can include depositing amorphous carbon on a substrate. Heating the carbon and the catalytic metal can include applying a rapid heating process to the carbon and the catalytic metal. The method can include patterning the catalytic metal before heating the carbon and the catalytic metal. Forming graphene on the substrate can include forming graphene having a pattern that is the same as the pattern of the catalytic metal. The method can include forming metal contacts on the patterned graphene. The method can include forming electronic components coupled to the metal contacts. Patterning the catalytic metal can include removing a portion of the catalytic metal. Heating the carbon and the catalytic metal can include heating the carbon and the catalytic metal in a vacuum chamber. Heating the carbon and the catalytic metal can include using a flashlamp to heat the carbon and the catalytic metal. Heating the carbon and the catalytic metal can include heating the carbon and the catalytic metal in a protection environment. Heating the carbon and catalytic metal can include applying a light beam to heat the carbon and catalytic metal. Applying a light beam to heat the carbon and catalytic metal can include applying a laser beam to heat the carbon and catalytic metal. Applying a light beam to heat the carbon and catalytic metal can include applying a flash lamp to heat the carbon and catalytic metal. Depositing carbon and catalytic metal on a substrate can include depositing carbon and catalytic metal on a substrate that does not interact with the carbon and the catalytic metal. The substrate can be a silicon oxide/silicon, sapphire, quartz, or glass substrate. The substrate can be a gold or copper substrate. Depositing catalytic metal can include using a thin film deposition process to deposit the catalytic metal. The thin film deposition process can include DC sputtering. The method can include fabricating an electronic device using the graphene as a transparent conductor. Fabricating an electronic device can include fabricating a display using the graphene as a transparent conductor.

In general, in another aspect, a method for fabricating a graphene pattern is provided. The method includes depositing carbon and catalytic metal on a substrate; applying a light beam to the carbon and the catalytic metal, the light beam to induce localized heating of the carbon and the catalytic metal; and forming graphene on the substrate at locations where the carbon and catalytic metal have been illuminated by the light beam.

Implementations of the method may include one or more of the following features. Depositing carbon and catalytic metal on a substrate can includes (1) depositing a layer of carbon on a substrate, and depositing a layer of catalytic metal on the layer of carbon, or (2) depositing a layer of catalytic metal on a substrate, and depositing a layer of carbon on the layer of catalytic metal. Depositing carbon and catalytic metal on a substrate can include co-depositing carbon and catalytic metal in a single layer on a substrate. The method can include evaporating the catalytic metal while heating the carbon and the catalytic metal with the light beam. Applying a light beam to the carbon and the catalytic metal can include applying a laser beam to the carbon and the catalytic metal. Applying a laser beam to the carbon and the catalytic metal can include applying at least one of a continuous wave or a pulsed laser beam to the carbon and the catalytic metal. Applying a light beam to the carbon and the catalytic metal can include applying a light beam to write a pattern on the catalytic metal and the carbon, and forming graphene on the substrate can include forming graphene having the pattern written by the light beam. Applying a light beam to write a pattern on the catalytic metal and carbon can include applying a light beam to write a pattern that correspond to conducting lines of an electronic circuit, and forming graphene on the substrate can include forming graphene having the pattern that correspond to conducting lines of an electronic circuit. The layer of carbon can have a thickness in a range from about 1 nm to 100 nm. The layer of catalytic metal can have a thickness in a range from about 1 nm to 1000 nm. Forming graphene can include forming mono-layer, bi-layer, or multi-layer graphene on the substrate. The method can include removing a portion of the catalytic metal that has not been illuminated by the light beam. Depositing carbon on a substrate can include depositing amorphous carbon on a substrate. Depositing carbon and catalytic metal on a substrate can include depositing carbon and catalytic metal on a substrate that does not interact with the carbon and the catalytic metal. The substrate can include a silicon oxide/silicon, sapphire, quartz, or glass substrate. The substrate can include a gold or copper substrate. Depositing catalytic metal can include using a thin film deposition process to deposit the catalytic metal. The thin film deposition process can include DC sputtering. The method can include fabricating an electronic device using the patterned graphene as a transparent conductor. Fabricating an electronic device can include fabricating a display using the patterned graphene as a transparent conductor.

The details of one or more of the above aspects ad implementations are set forth in the accompanying drawings and the description below. Other features, aspects, and advantages will become apparent from the description, the drawings, and the claims.

### DESCRIPTION OF DRAWINGS

FIG. 1 is a diagram showing a process for fabricating graphene on a substrate.

FIG. 2 shows images of graphene grown on SiO₂/Si, sapphire, quartz, and fused silica glass substrates.

FIGS. 3 and 4 are large-area Raman mapping images.

FIG. 5 is an image of patterned nickel/carbon layer on a SiO₂/Si substrate.

FIG. 6 is an image of patterned graphene on the SiO₂/Si substrate.

FIG. 7 is a diagram of a process for fabricating graphene on a substrate.

FIGS. 8A and 8B are images of a Ni/C/SiO₂/Si wafer in a heating tube used in a rapid thermal process.

FIG. 9 show images of various wafers of Ni/C/substrate before and after a rapid thermal process.

FIG. 10 is a graph showing a Raman spectrum of a graphene sample.

FIG. 11 is a graph showing an optical transmittance spectrum of the graphene sample.

FIG. 12A is an optical micrograph showing graphene formed on a SiO₂/Si substrate.

FIG. 12B is an atomic force microscope topographic image showing graphene on the SiO₂/Si substrate.

FIG. 12C is a graph showing Raman spectra of the graphene having different numbers of layers in Raman mapping of graphene on a SiO₂/Si substrate.

FIG. 12D is a graph showing Raman mapping of I_{2D}/I_{G} ratio in a region of the SiO₂/Si substrate.

FIG. 13A is an image showing two wafers of Ni/C/quartz and Ni/quartz before the rapid thermal process.

FIG. 13B is an image showing the two wafers after the rapid thermal process.

FIG. 14A is a graph showing the Raman spectra of graphene samples produced using nickel of various thicknesses.

FIG. 14B is a graph 320 showing the relationship between the ratios of Raman peak intensities of the graphene samples, and the thicknesses of the initial nickel films that were used to produce the graphene samples.

FIG. 15A is a graph showing the Raman spectra of graphene samples that were produced using carbon film of various thicknesses.

FIG. 15B is a graph showing the relationship between the ratios of the Raman peak intensities of the graphene samples and the thicknesses of the carbon films used to produce the graphene.

FIG. 16 is a chart showing the characteristics of examples of mono-layer, bi-layer, and multi-layer graphene sheets.

FIG. 17 is a graph 460 showing the optical transmittance and sheet resistance of various graphene samples and ITO glasses.

FIG. 18A is a diagram of a graphene transistor.

FIG. 18B is a graph showing the relationships between drain-source current and drain-source voltage.

FIG. 18C is a graph showing the relationship between drain-source current and gate-source voltage.

FIG. 19 is a diagram of a process for generating graphene patterns using a laser direct writing method.

FIG. 20 show an optical micrograph and a Raman image of a graphene pattern produced using the laser direct writing process.

FIGS. 21A to 21D show images of graphene patterns, including texts, spirals, parallel lines, and layouts of integrated circuits, that were produced using the laser direct writing method.

FIG. 22 is a scanning electron microscope micrograph showing a graphene line produced using the laser direct writing method.

FIG. 23 is a graph showing a Raman spectrum of graphene lines produced using the laser direct writing method.

FIG. 24A is a diagram of an integrated circuit layout design.

FIG. 24B is an image of graphene conductor lines.

FIG. 24C shows images of a wafer and graphene patterns on the wafer.

FIG. 25 is a diagram of a process for generating large-scale graphene-based integrated circuit patterns.

FIG. 26 shows images of a wafer and graphene patterns on the wafer.

FIGS. 27 to 32 are flow diagrams of processes for fabricating graphene.

Like reference symbols in the various drawings indicate like elements.

### DETAILED DESCRIPTION

This disclosure provides a novel approach for growing graphene films and forming graphene patterns. Carbon and catalytic metal are deposited on a substrate, the carbon and the catalytic metal are heated, and graphene is formed on the substrate. The catalytic metal is evaporated in the heating process, so only graphene remains on the substrate. Using this novel process, it is not necessary to use toxic precursors such as H₂ and CH₄. The substrate can be a dielectric substrate on which an electronic circuit can be built, so there is no need to apply a graphene transfer process to transfer the graphene from an intermediate substrate to a final substrate.

In some implementations, a layer of amorphous carbon is deposited on the substrate using thin film deposition techniques, e.g., a DC sputtering method. Similar, a layer of catalytic metal can be deposited on the carbon layer using a DC sputtering method. In some implementations, a layer of catalytic metal is deposited on the substrate, and a layer of carbon is deposited on the catalytic metal layer. In some implementations, carbon and catalytic metal are co-deposited in a single layer on the substrate using thin film deposition techniques, e.g., a DC co-sputtering method.

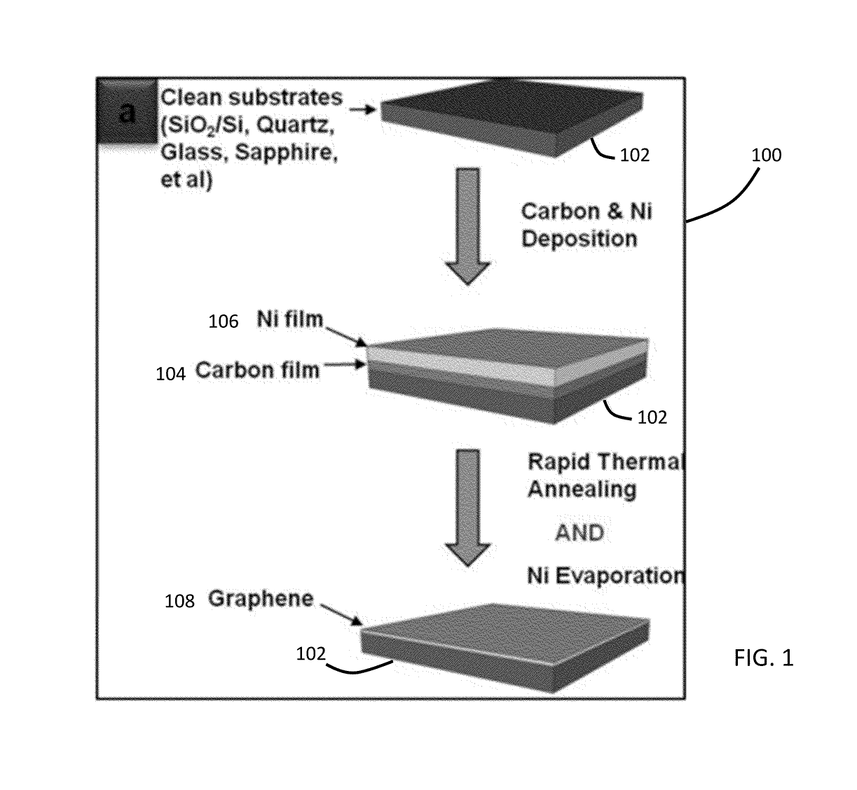

Referring to FIG. 1, a diagram 100 illustrates exemplary steps for fabricating graphene on a substrate. A clean substrate 102 is prepared. For example, the substrate 102 can be a silicon oxide/silicon (which refers to a silicon substrate having a thin layer of silicon oxide), quartz, sapphire, silica glass substrate, or a substrate made of other materials (e.g., dielectric materials). A layer of carbon 104 (or a carbon film) is formed on the substrate 102. For example, the layer of carbon 104 can be a layer of amorphous carbon having a thickness in a range between about 1 nm to 100 nm (or in some examples, between about 2 nm to 8 nm) that is deposited using DC sputtering. A layer of nickel 106 (or a nickel film) is formed on the layer of carbon 104. For example, the layer of nickel can be deposited on the layer of carbon using DC sputtering. The layer of nickel can have a thickness in a range from about 1 nm to 1000 nm (or in some examples, from about 50 nm to 120 nm, or from about 50 nm to 95 nm).

The layer of carbon and the layer of nickel are heated. For example, a rapid thermal process can be used. The substrate along with the carbon and nickel films are placed in an oven, and a vacuum pump reduces the pressure in the oven to, e.g., about 100 mTorr. The oven is rapidly heated to a high temperature in a range between about 900° C. to 1100° C. for about 1 to 2 minutes, followed by a fast cooling process to room temperature. The nickel top layer autonomously evaporates during the rapid thermal process, leaving bare graphene deposited on the dielectric surface. During the rapid thermal process, the nickel film is thermally evaporated. After the rapid thermal process, graphene 108 is formed on the substrate 102. The rapid thermal process is applied in a low pressure condition to reduce the oxidation of the nickel and graphene. The fast cooling is also designed to reduce the amount of oxidation. By applying the rapid thermal process in a low pressure condition, no additional gas needs to be introduced into the oven. In some examples, inert gas can be introduced into the oven to reduce oxidation of the carbon and graphene. In that case, there is no need to reduce the pressure inside the oven.

In some examples, when the carbon film has a thickness of 5 nm, and the nickel film has a thickness in a range from 50 nm to 95 nm, high-quality graphene is uniformly formed on the whole wafer after the evaporation of the nickel top layer. The graphene formed using the process described above can be mono-layer graphene, bi-layer graphene, or few-layer graphene (which has three or more layers of graphene). In some implementations, which type of graphene is formed can be determined by the ratio of the thickness of the carbon layer and the thickness of the nickel layer. In some examples, when the nickel film has a thickness of 65 nm and the carbon film has a thickness in a range from about 2 to 5 nm, mono-layer graphene is produced. In some examples, when the nickel film has a thickness of 65 nm and the carbon film has a thickness in a range from about 5 to 7 nm, bi-layer graphene is produced. In some examples, when the nickel film has a thickness of 65 nm and the carbon film has a thickness in a range from about 7 to 8 nm, few-layer graphene is produced, in which the few-layer graphene has three or more layers of graphene.

In the example shown in FIG. 1, a layer of nickel is deposited on a layer of carbon. In some implementations, a layer of nickel is deposited on the substrate, then a layer of carbon is deposited on the layer of nickel. In some implementations, carbon and nickel are co-deposited in a single film on the substrate. For example, the carbon and nickel can be co-deposited by DC magnetron sputtering using both graphite and nickel targets. The nickel can be replaced by other catalytic metals, such as cobalt or iron. The thicknesses of the carbon layer and the catalytic metal layer, the ratio between the thicknesses of the carbon and the catalytic metal layers, or the ratio of the amounts of carbon and catalytic metal being deposited, can be selected based on the type of catalytic metal used in order to produce a desired type of graphene (e.g., mono-layer, bi-layer, or multi-layer graphene).

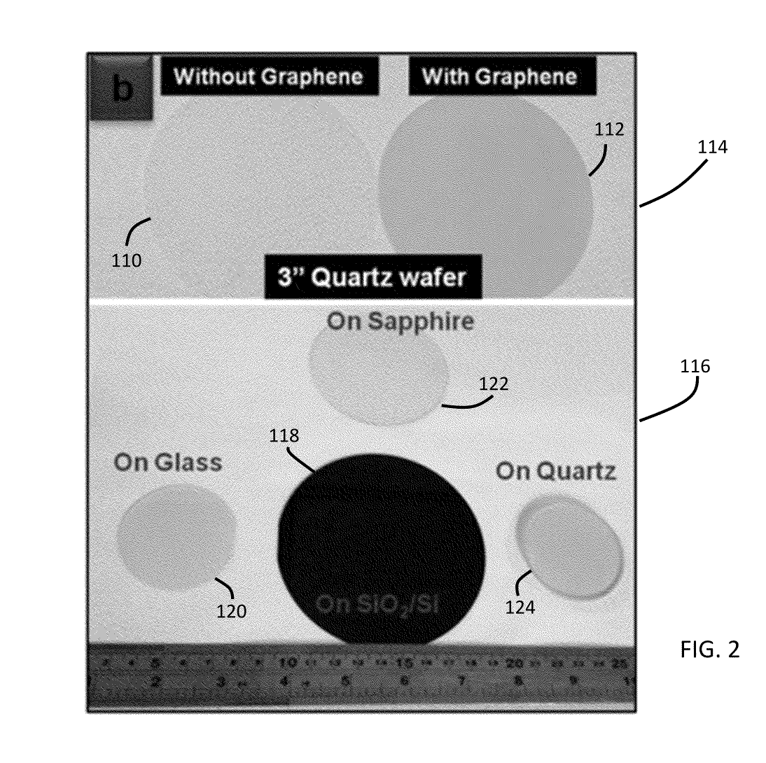

Referring to FIG. 2, a photograph 114 shows a 3-inch quartz wafer 110 that does not have graphene and a 3-inch quartz wafer 112 that has graphene grown on the top of the wafer. A photograph 116 shows graphene on a silicon oxide/silicon (SiO₂/Si) substrate 118, graphene on a glass substrate 120, graphene on a sapphire substrate 122, and graphene on a quartz substrate 124. The graphene films on the substrates 112, 118, 120, 122, and 124 were grown using the method described above and illustrated in FIG. 1.

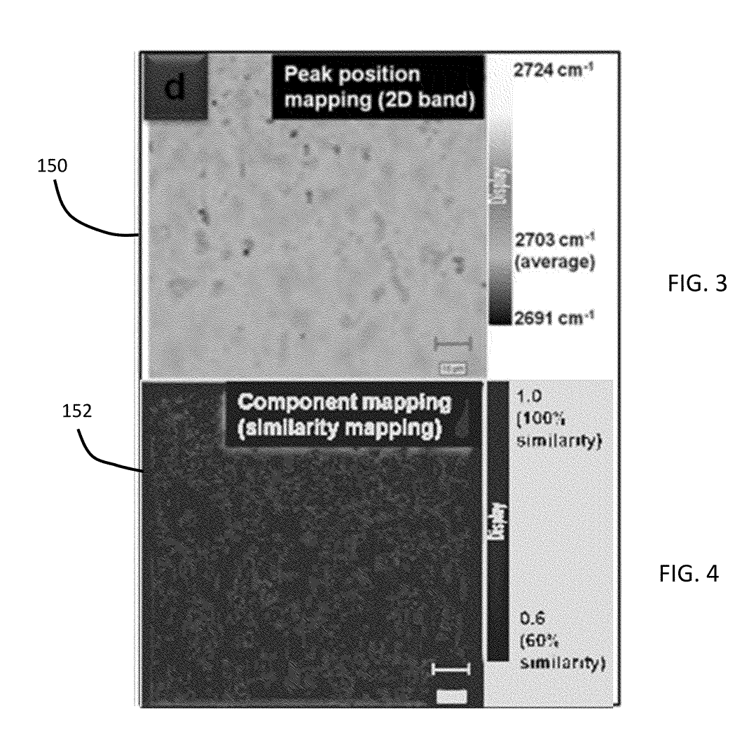

Referring to FIGS. 3 and 4, large-area Raman mapping images 150 and 152 show the good coverage and uniformity of the graphene sheets on the substrates. The sheet resistance of the as-grown graphene has been measured to be less than 100 ohm/square, which is suitable for several industrial applications as a replacement of indium-tin-oxide (ITO). In some examples, mono-layer graphene produced using the method described above can have a low sheet resistance of about 50 ohms/square and a high optical transmittance of 95.8% at 550 nm.

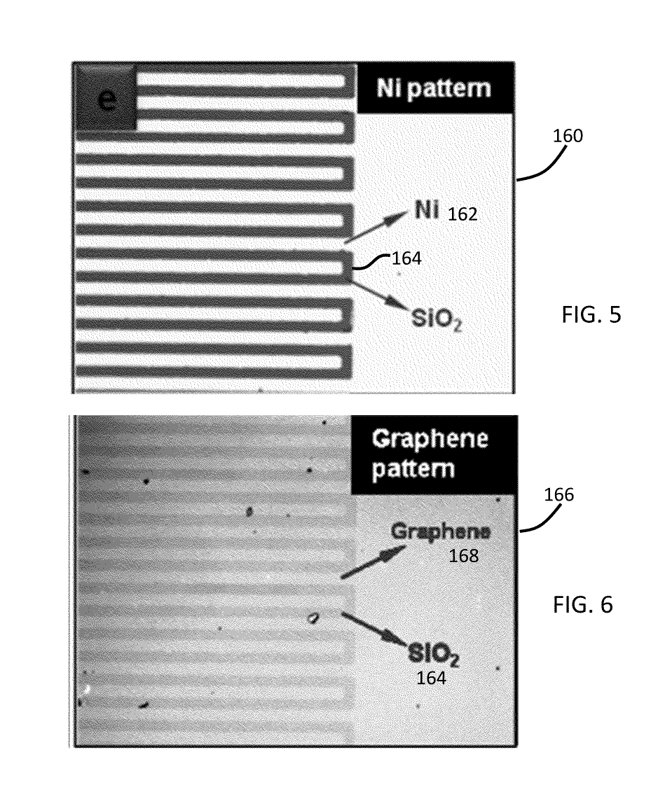

In some implementations, using a photolithography process, large-scale graphene patterns can be directly fabricated on various dielectric substrates, such as SiO₂/Si wafers, without the need of graphene transfer process. This may facilitate the fabrication of graphene-based nano-electronics. For example, comb-shaped graphene patterns were fabricated by patterning nickel/carbon films through a photolithography process, followed by the rapid thermal process. Referring to FIG. 5, an image 160 shows, after the photolithography process, regions 162 where the nickel film remained and regions 164 where no nickel film and amorphous carbon film were deposited.

Referring to FIG. 6, after a rapid thermal process was applied to the sample shown in the image 160 of FIG. 5, graphene was formed at the regions where the nickel film and the amorphous carbon film remained on the substrate prior to the rapid thermal process. An image 166 shows graphene 168 having a pattern that is the same as the pattern of the nickel film in the image 160. Because standard semiconductor photolithography process can be used to pattern the graphene film, the above technique for graphene growth can be suitable for a wide range of industrial applications, such as fabrication of transparent electrodes, flat-panel displays, solar cells, and other electronic devices.

Growing graphene by use of carbon and nickel films may have one or more of the following advantages. The fabrication process is simple, scalable, and compatible to existing infrastructures in the industry. In the fabrication process described above, DC sputtering and rapid thermal process are both compatible to the infrastructures in microelectronics and display industries. The photolithography equipment used for the fabrication of graphene patterns is also commonly available in the semiconductor industry. The cost of producing graphene is low. The fabrication process is safe because no explosive or toxic precursor gases, such as H₂ and CH₄, are needed in the process. It is possible to just use a protection environment (e.g., argon gas) in the rapid thermal process.

The graphene can have a high quality and uniformity. For example, mono-layer and bi-layer graphene can be steadily produced on large dielectric wafers. The graphene can have a high electrical conductivity. For example, the graphene can have a sheet resistance of less than 100 ohm/square, which is less than the sheet resistance of graphene produced by some other methods. It is possible that the graphene has a low sheet resistance because the graphene has few wrinkles.

FIG. 7 is a diagram 170 showing a process for growing graphene. This is the same process as that shown in FIG. 1, but with the graphene layer illustrated with better clarity. A clean substrate 102 is prepared. A carbon film 104 (e.g., amorphous carbon film) is deposited on the substrate 102. A nickel film 106 is deposited on the carbon film 104. A rapid thermal process 172 is applied to rapidly heat the carbon and nickel films for a brief period of time, followed by a fast cooling process. After the rapid thermal process, graphene 108 is formed on the substrate 102.

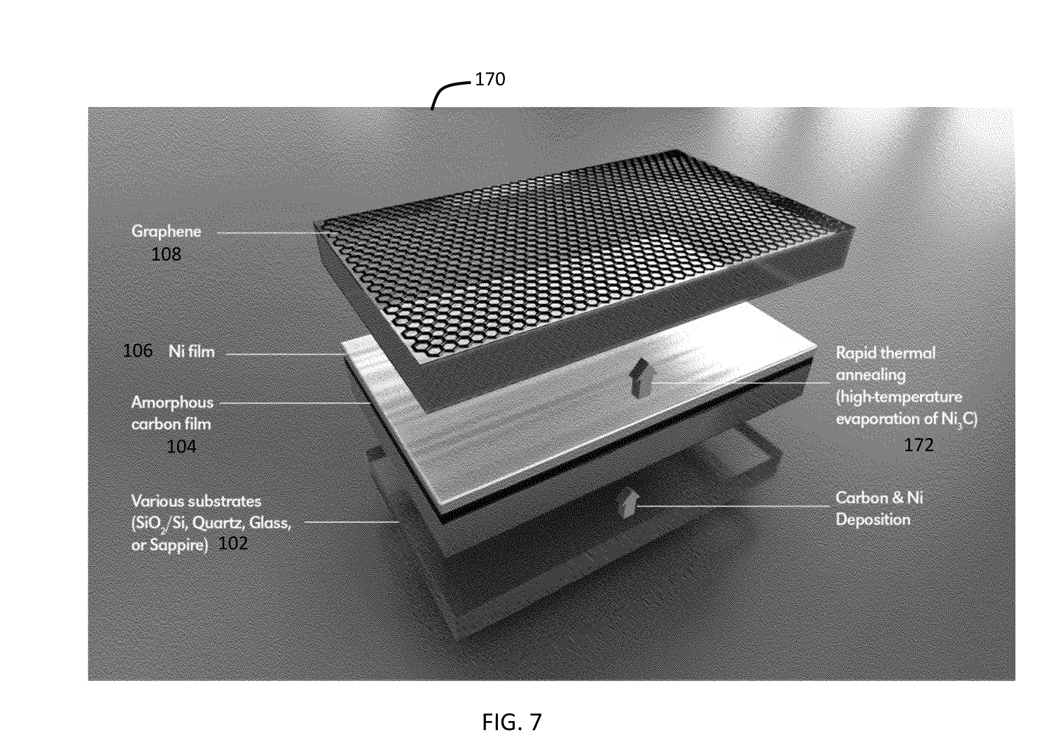

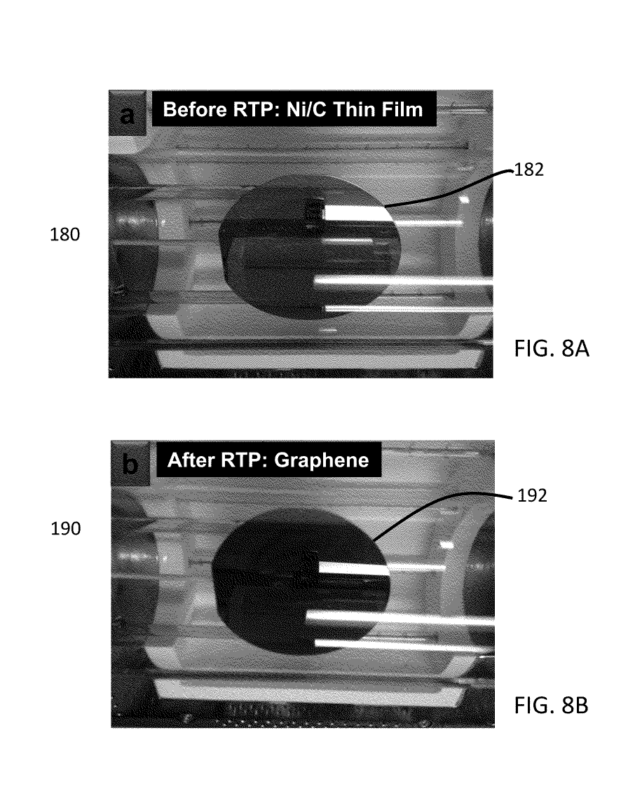

Referring to FIG. 8A, an image 180 shows a wafer 182 having carbon and nickel thin films before the rapid thermal process. The wafer 182 is placed in a heating tube. Referring to FIG. 8B, an image 190 shows that after the rapid thermal process, the wafer 182 turns into a wafer 192 having graphene.

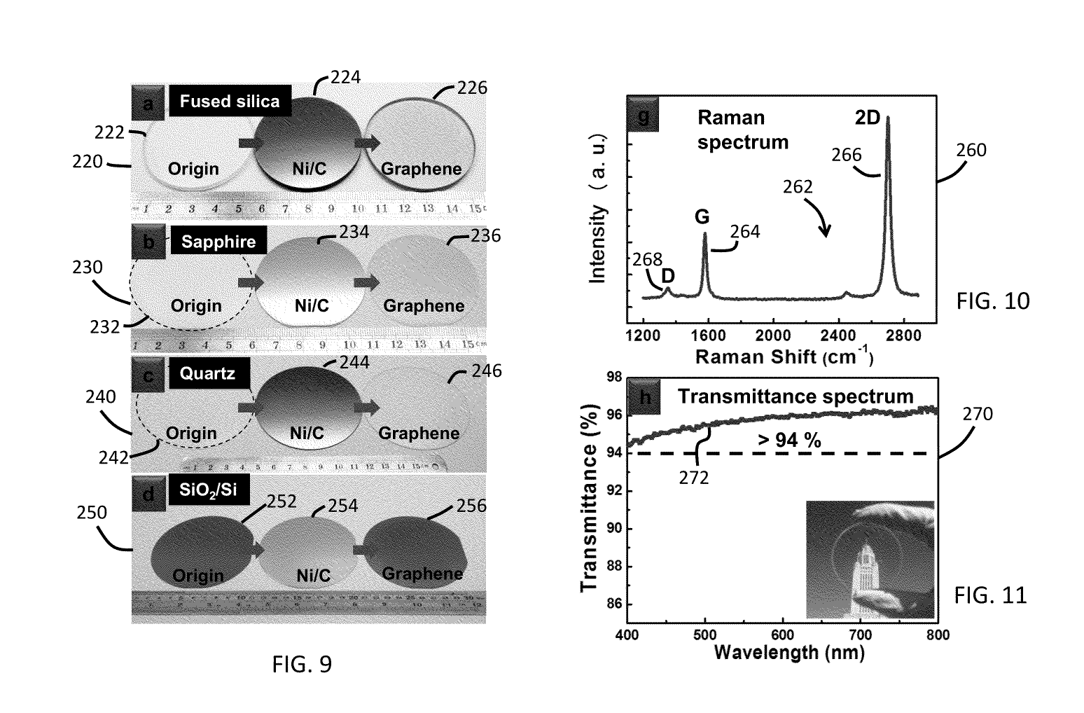

Referring to FIG. 9, an image 220 shows a 2-inch fused silica substrate 222 on which a carbon film and a nickel film 224 were deposited. After the rapid thermal process, graphene 226 was produced on the substrate. An image 230 shows a 2-inch sapphire substrate 232 on which a carbon film and a nickel film 234 were deposited. After the rapid thermal process, graphene 236 was produced on the substrate. An image 240 shows a 3-inch quartz substrate 242 on which a carbon film and a nickel film 244 were deposited. After the rapid thermal process, graphene 246 was produced on the substrate. An image 250 shows a 4-inch SiO₂/Si substrate 252 on which a carbon film and a nickel film 254 were deposited. After the rapid thermal process, graphene 256 was produced on the substrate. Scanning electron microscopy (SEM) images of the rapid thermal process graphene does not show visible graphene wrinkles In the following description, the graphene prepared using the rapid thermal process method is referred as rapid thermal process graphene.

To produce the graphene samples shown in FIG. 9, the substrates or wafers were first cleaned by a standard cleaning process. The cleaned wafers were deposited with an amorphous carbon film having a thickness of 5 nm and a nickel film having a thickness of 65 nm by direct-current (DC) magnetron sputtering using graphite (Kurt J. Lesker, 99.999% purity) and nickel (Kurt J. Lesker, 99.995% purity) targets at room temperature. The nickel/carbon-coated wafers were then loaded into a rapid thermal process system (MTI, OTF-1200X-4-RTP). The rapid thermal process tube was repeatedly purged with high-purity argon (Ar) gas about 3 to 5 times to remove the air from the tube. The rapid thermal process tube was pumped down and maintained at 20 mTorr. The rapid thermal process started at room temperature. The temperature was increased to 1100° C. at a rate of 500° C. min⁻¹, kept unchanged at 1100° C. for 2 minutes, and reduced to room temperature at a rate of 60° C. min⁻¹. The wafers were removed from the tube for characterization without further post-growth treatments.

Referring to FIG. 10, a graph 260 shows a Raman spectrum 262 of the graphene 226 on the fused silica wafer. The Raman spectrum 262 indicates the graphene 226 has sharp and strong G band 264 (1582 cm⁻¹) and 2D band 266 (2700 cm⁻¹), accompanied by a weak D band 268 (1357 cm⁻¹). The I_{2D}/I_{G} ratio of 2.5 indicates the formation of monolayer graphene.

Referring to FIG. 11, a graph 270 shows an optical transmittance spectrum 272 of the graphene 226 on the fused silica wafer. The spectrum 272 indicates that the graphene 226 has greater than 94% transmittance for wavelengths in a range from 400 nm to 800 nm. The optical transmittance at 550 nm is about 95.8%. This shows the rapid thermal process graphene has high quality and high transparency.

To determine the properties of the graphene that was grown using the rapid thermal process, the surface morphologies of the graphene samples were characterized by a field-emission scanning electron microscope (FE-SEM) (Hitachi S4700 FESEM system, 5 kV) and a Digital Instruments EnviroScope atomic force microscope (AFM) in tapping mode (Veeco Instruments Inc.). The Raman characterization of the graphene samples was conducted using a Renishaw InVia Raman microscope with an excitation wavelength of 514.5 nm and a lateral resolution of about 1 μm. The Raman mapping was carried out with a grid spacing of 0.25 μm and an accumulation time of 3 s at each spot. Sheet-resistance measurements were performed using a four-point resistivity meter (EDTM, R-Chek Surface Resistivity Meter-RC2175).

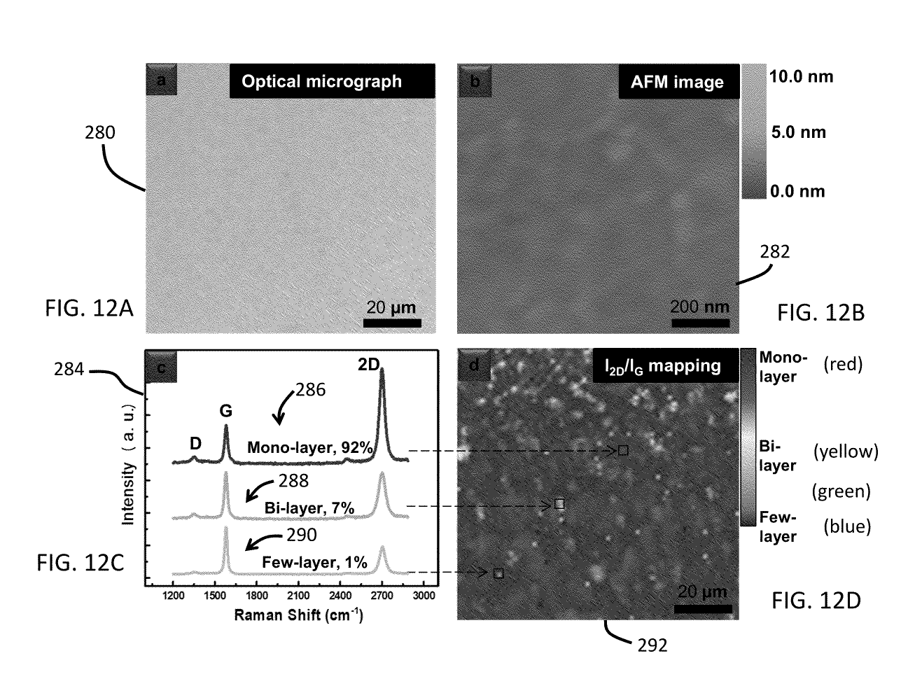

Referring to FIG. 12A, an optical micrograph 280 shows graphene formed on a SiO₂/Si substrate (300 nm of SiO₂) (scale bar in the figure is 20 μm). Low contrast in the optical micrograph provides evidence of the uniformity of the rapid thermal process graphene.

Referring to FIG. 12B, a tapping-mode atomic force microscope (AFM) topographic image 282 shows graphene on the SiO₂/Si substrate (scale bar: 200 nm). The atomic force microscope image of the rapid thermal process graphene exhibits a smooth surface with a root mean square (RMS) roughness of about 0.283 nm. No obvious wrinkles and boundaries are observed in the rapid thermal process graphene. In this example, because the nickel top layer is evaporated in the rapid thermal process, leaving no stress on the remaining graphene during the cooling process, wrinkle formation can be efficiently avoided. As a result, the rapid thermal process graphene has a high electrical conductance. In some examples, a small signal associated with nickel was found in the rapid thermal process graphene using energy-dispersive X-ray (EDX) spectroscopy. The low sheet resistance of the rapid thermal process graphene may be the result of a combination of (1) a large domain size, (2) nickel doping, and (3) wrinkle-free graphene. In some examples, under optimal conditions, the sheet resistance can be as low as 50Ω/sq, near the theoretical limit (30Ω/sq). The high electrical conductivity and optical transparency (about 96% transmittance at about 50Ω/sq) of the rapid thermal process graphene outperform those of indium tin oxide (ITO) (about 80% transmittance at about 88Ω/sq). Thus, the rapid thermal process graphene has the potential to replace ITO as transparent electrode material.

The quality and uniformity of the rapid thermal process graphene was characterized using Raman spectroscopy by mapping the I_{2D}/I_{G} ratio, the peak position of the 2D band, and the full-width at half-maximum (FWHM) of the 2D band. Referring to FIG. 12C, a graph 284 shows Raman spectra of the graphene with different numbers of layers in Raman mapping of graphene on a SiO₂/Si substrate, including a Raman spectrum 286 of mono-layer graphene, a Raman spectrum 288 of bi-layer graphene, and a Raman spectrum 290 of few-layer graphene. The I_{2D}/I_{G} ratio decreases as the number of graphene layer increases. In general, a I_{2D}/I_{G} ratio in a range between 0.8 and 1.4 represents the formation of bilayer graphene. The monolayer graphene can be identified with an I_{2D}/I_{G} ratio greater than 1.4, and few-layer graphene with more than three graphene layers can be identified with an I_{2D}/I_{G} ratio less than 0.8.

Referring to FIG. 12D, a graph 292 shows Raman mapping of I_{2D}/I_{G} ratio in a 100 μm×100 μm region (scale bar: 20 μm, processing software: Renishaw WiRE 3.2). The regions of different colors represent graphene of different layer numbers, as characterized by the corresponding Raman spectra in FIG. 12C. It shows that most areas are in red color with only a few spots in other colors, indicating uniform growth of the monolayer graphene on the SiO₂ surface. Peak-position and full-width-at-half-maximum mapping of the 2D band also confirm the coverage dominantly by monolayer graphene. Based on the Raman mapping, the rapid thermal process graphene includes 92% monolayer, 7% bilayer, and 1% few-layer graphene, indicating the high uniformity of the graphene deposition.

The nickel film autonomously evaporates during the rapid thermal process, providing two advantages: (1) eliminating the need for the post-growth catalyst etching and graphene transfer, and (2) limiting the wrinkle formation in graphene caused by the differences in the thermal expansion coefficients. The evaporation temperature of nickel is 2913° C., much higher than the rapid thermal process temperature of 1100° C. The existence of amorphous carbon enables the evaporation of nickel at 1100° C.

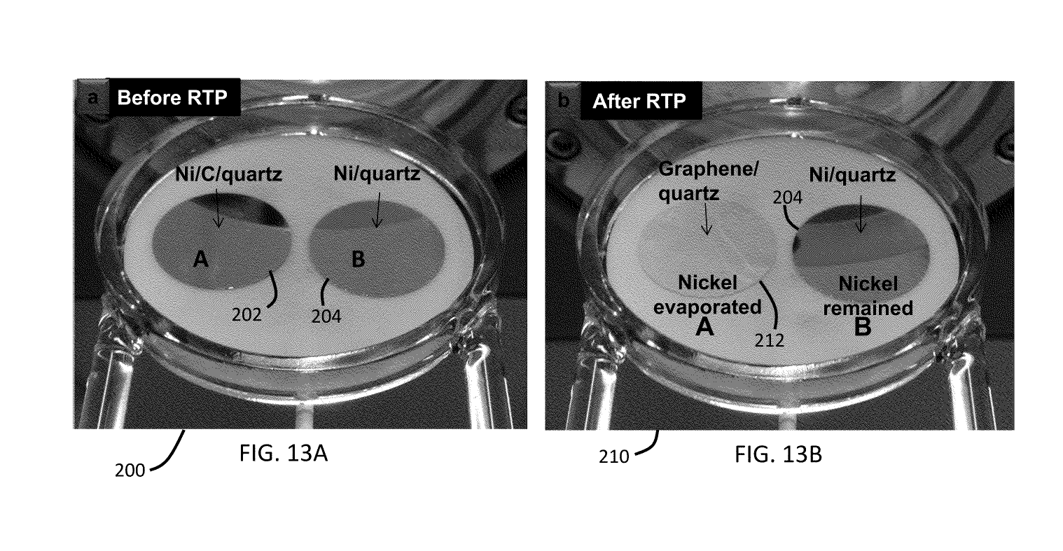

To prove the role of amorphous carbon in nickel evaporation, nickel films (65 nm) deposited on quartz substrates with and without a sandwich layer of amorphous carbon (5 nm) were prepared and subjected to the same rapid thermal process. Referring to FIG. 13A, an image 200 shows a quartz wafer 202 having carbon and nickel thin films and a quartz wafer 204 having a nickel film (without the carbon film) before the rapid thermal process. Referring to FIG. 13B, an image 210 shows that after the rapid thermal process, the quartz wafer 202 turned into a quartz wafer 212, in which graphene has been formed on the wafer. After the rapid thermal process, the nickel-coated quartz substrate 204 was no different in appearance before and after the rapid thermal process, indicating that the nickel remained on the quartz wafer 204 after the rapid thermal process. However, the nickel top layer was completely evaporated from the nickel/carbon-coated quartz substrate 212 after the rapid thermal process, which is clearly evidenced by the change in the surface appearance. This indicates that the amorphous carbon layer has influence on the evaporation of nickel at 1100° C.

Without being bound by the theory presented here, it is possible that the formation, decomposition, and evaporation of nickel carbide at an elevated temperature may result in the autonomous evaporation of nickel and transfer-free growth of graphene on the dielectric surfaces. It is possible that metastable nickel carbide (Ni₃C) phase can be formed at the interface between the nickel film and the carbon film at a temperature below 400° C., and the Ni₃C phase starts to decompose at a temperature above 400° C. The thickness of the Ni₃C layer formed at the nickel-carbon interfaces can be about tens of nanometers. The formation and decomposition of the Ni₃C phase may contribute to the formation of graphene. Accompanying the decomposition of Ni₃C, a layer of graphene can be precipitated from the Ni₃C phase on the dielectric substrate surfaces. The remnant nickel can be evaporated at a temperature around 1100° C. in the rapid thermal process. The graphene layer can remain at the rapid thermal process temperature of 1100° C., which is lower than the graphene melting point about 3000° C. It is possible that the graphene growth and autonomous nickel evaporation are the results of the formation, decomposition, and evaporation of Ni₃C in the rapid thermal process.

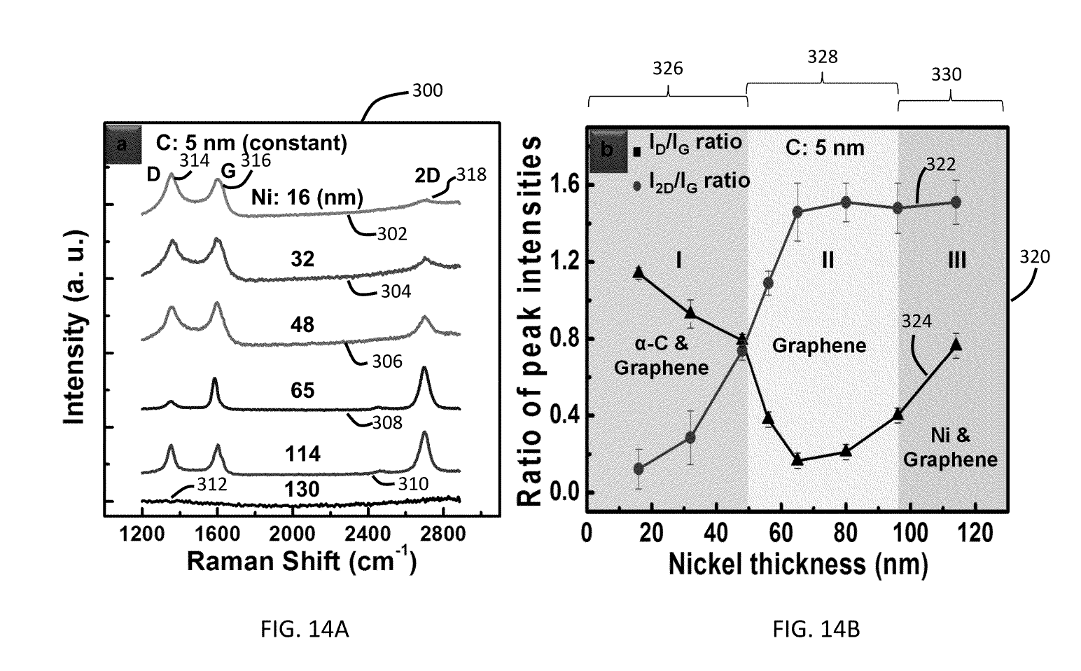

Due to the dependence of Ni₃C stability on the Ni/C ratio, it is possible that the nickel/carbon ratio affects the rapid thermal process graphene growth and influences the number of graphene layers grown on the substrate. A series of experiments have been conducted by adjusting the nickel/carbon ratio. FIGS. 14A and 14B show measurements for samples in which the thickness of the carbon films was fixed at 5 nm, and the nickel films varied from 16 nm to 130 nm in thickness.

Referring to FIG. 14A, a graph 300 shows the Raman spectra 302, 304, 306, 308, 310, and 312 of the samples with nickel thicknesses 16 nm, 32 nm, 48 nm, 65 nm, 114 nm, and 130 nm, respectively. Each Raman spectrum shows a D peak 314, a G peak 316, and a 2D peak 318. Different Raman spectra have different ratios of peak intensities I_{D}/I_{G} and I_{2D}/I_{G}. Amorphous carbon films, bare graphene, and nickel-covered graphene were obtained as the nickel film thickness increased.

Referring to FIG. 14B, a graph 320 shows the relationship between the ratios of peak intensities of the graphene samples, and the thicknesses of the initial nickel films that were used to produce the graphene samples. A curve 322 represents the relationship between the ratios of intensities of the 2D peak and the G peak versus nickel film thickness. A curve 324 represents the relationship between the ratios of intensities of the D peak and the G peak versus nickel film thickness. When the thickness of the thin nickel films is below 50 nm (associated with Raman spectra 302, 304, and 306), amorphous carbon remains after the rapid thermal process. When the thicknesses of the thin nickel films are below 50 nm (region I 326), the I_{D}/I_{G} ratios are relatively high and the I_{2D}/I_{G} ratios are relatively small, indicating that amorphous graphene remained after the rapid thermal process. When the thicknesses of the thin nickel films are in the range from 50 nm to 95 nm (region II 328), the I_{D}/I_{G} ratios are relatively low and the I_{2D}/I_{G} ratios are relatively high, indicating that bare graphene sheets are formed on the substrates after the rapid thermal process. When the thicknesses of the nickel films exceed 95 nm (region III 330), nickel-covered graphene is formed on the substrate.

In FIG. 14A, the Raman spectrum 310 is measured from graphene grown with an initial nickel film thickness of 114 nm. The Raman spectrum 310 shows that the I_{2D}/I_{G} ratio has a high value 1.42, which suggests the formation of mono-layer graphene. In this example, some nickel remained after the rapid thermal process. The remaining nickel was removed by etching, and the Raman spectrum 310 was obtained after nickel was etched graphene precipitation from nickel and/or the disrupted graphene lattice caused by the nickel etching, When the nickel film exceeded 130 nm, no carbon residual was observed due to the complete carbon dissolution in nickel.

The results described above show a strong dependence of graphene quality on nickel film thickness in the rapid thermal process. When the nickel film thickness is below 50 nm, as shown in FIG. 14B region I 326, excessive amorphous carbon films remain on substrate surfaces with only a small amount of graphene formed after the complete evaporation of nickel films. When the nickel film thickness is in the range from 50 to 95 nm, as shown in region II 328, high-quality graphene is uniformly formed on the whole wafer after the evaporation of the nickel top layer. When the nickel film thickness exceeds 95 nm, some nickel remains on the substrate. The data in the graph 320 confirms the importance of the nickel/carbon ratio in the formation of graphene by the rapid thermal process.

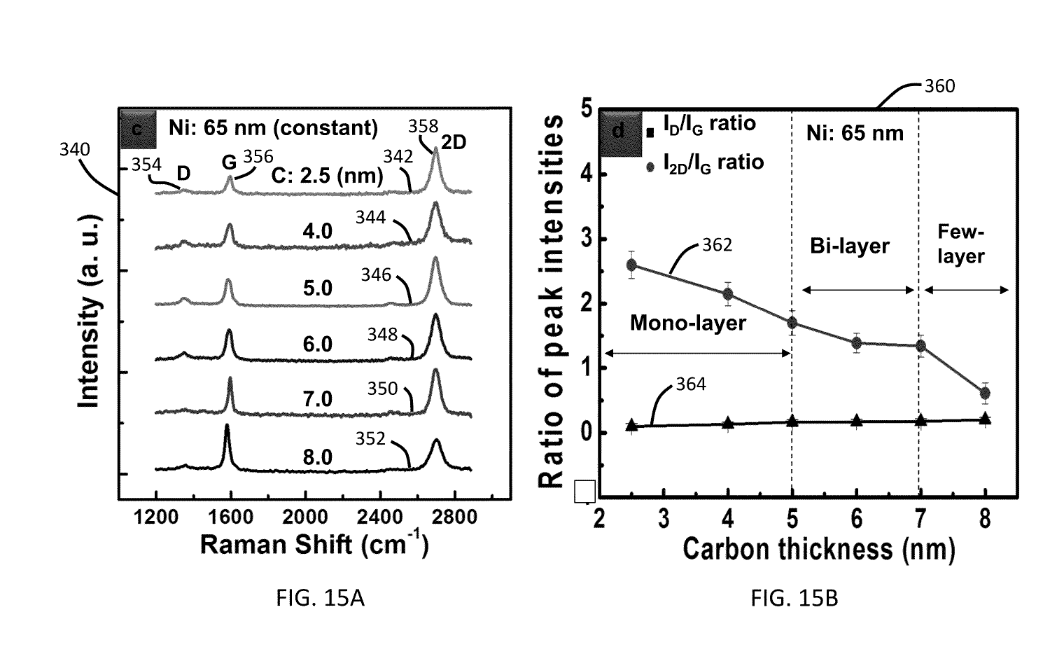

FIGS. 15A and 15B show measurements for samples in which the thickness of the nickel films was fixed at 65 nm, and the carbon films varied from 2.5 nm to 8 nm in thickness. Referring FIG. 15A, a graph 340 shows the Raman spectra 342, 344, 346, 348, 350, and 352 of the graphene samples that were produced using carbon film thicknesses 2.5 nm, 4.0 nm, 5.0 nm, 6.0 nm, 7.0 nm, and 8.0 nm, respectively. Each Raman spectrum shows a D peak 354, a G peak 356, and a 2D peak 358. Referring to FIG. 15B, a graph 360 shows the relationship between the ratio of peak intensities of the graphene samples and the thicknesses of the carbon films used to produce the graphene. A curve 362 shows the relationship between I_{2D}/I_{G} ratio and the carbon thickness. A curve 364 shows the relationship between I_{D}/I_{G} ratio and the carbon thickness. Different Raman spectra have different ratios of peak intensities I_{2D}/I_{G}, while the ratios of peak intensities I_{D}/I_{G} are similar across different samples. When the carbon film thickness increases, the I_{2D}/I_{G} ratio decreases accordingly from 2.6 to 0.6, indicating the increased number of graphene layers. The I_{2D}/I_{G} ratios of the Raman spectra indicate that monolayer, bilayer, and few-layer graphene sheets were obtained in the carbon film thickness ranges of about 2 nm to 5 nm, about 5 nm to 7 nm, and about 7 nm to 8 nm, respectively.

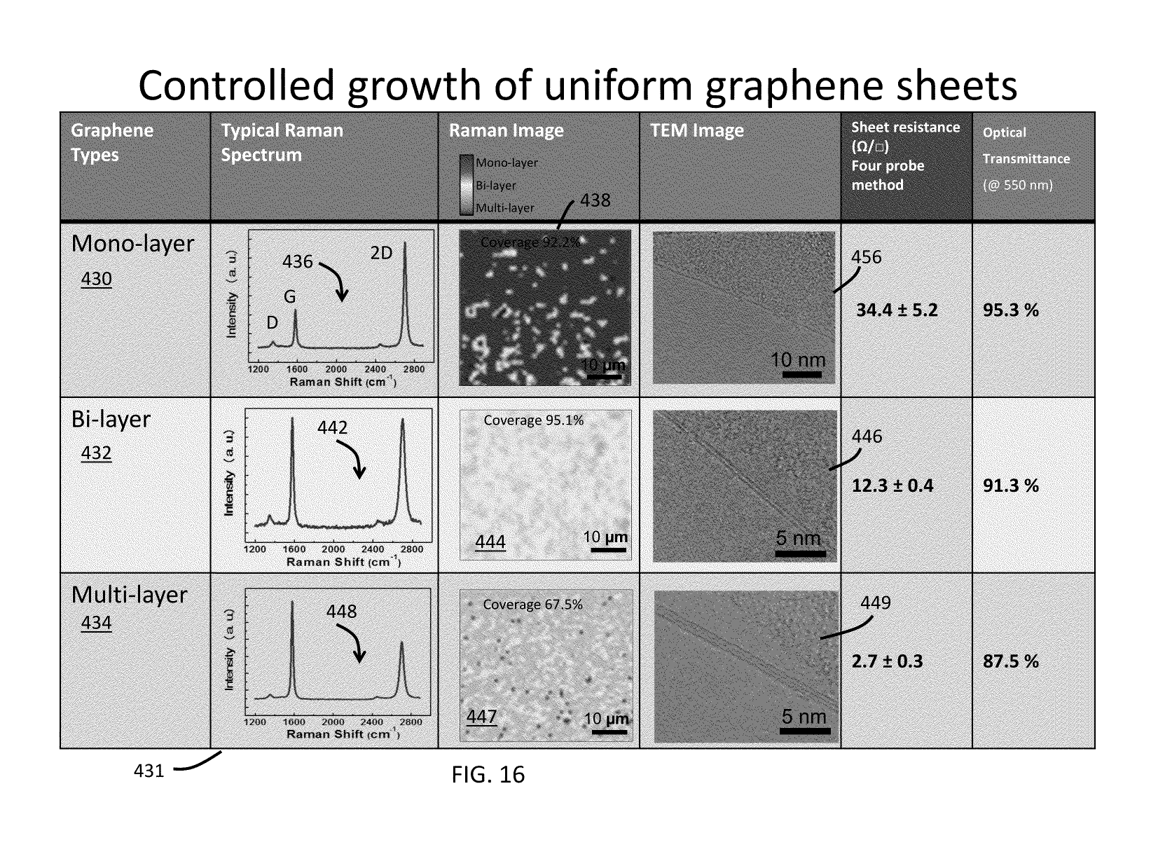

FIG. 16 shows a chart 431 showing the characteristics of examples of mono-layer, bi-layer, and multi-layer graphene sheets that are grown using the rapid thermal process. For a mono-layer graphene sample 430, a Raman spectrum 436 indicates a high I_{2D}/I_{G} ratio, and a Raman image 438 shows that the mono-layer graphene has a coverage of about 92.2%. A TEM image 456 shows a single layer of graphene sheet. The sheet resistance (measured using the four probe method) of the mono-layer graphene is about 34.4±5.2Ω/sq, and the optical transmittance at 550 nm is about 95.3%.

For a bi-layer graphene sample 432, a Raman spectrum 442 indicates that the G peak intensity and the 2D peak intensity are about the same, and a Raman image 444 shows that the bi-layer graphene has a coverage of about 95.1%. A TEM image 446 shows two layers of graphene sheets. The sheet resistance of the bi-layer graphene is about 12.3±0.4Ω/sq, and the optical transmittance at 550 nm is about 91.3%.

For a multi-layer graphene sample 434, a Raman spectrum 448 indicates that the G peak intensity is higher than the 2D peak intensity, and a Raman image 447 shows that the multi-layer graphene has a coverage of about 67.5%. A TEM image 449 shows three layers of graphene sheets. The sheet resistance of the multi-layer graphene is about 2.7±0.3ΩI/sq, and the optical transmittance at 550 nm is about 87.5%.

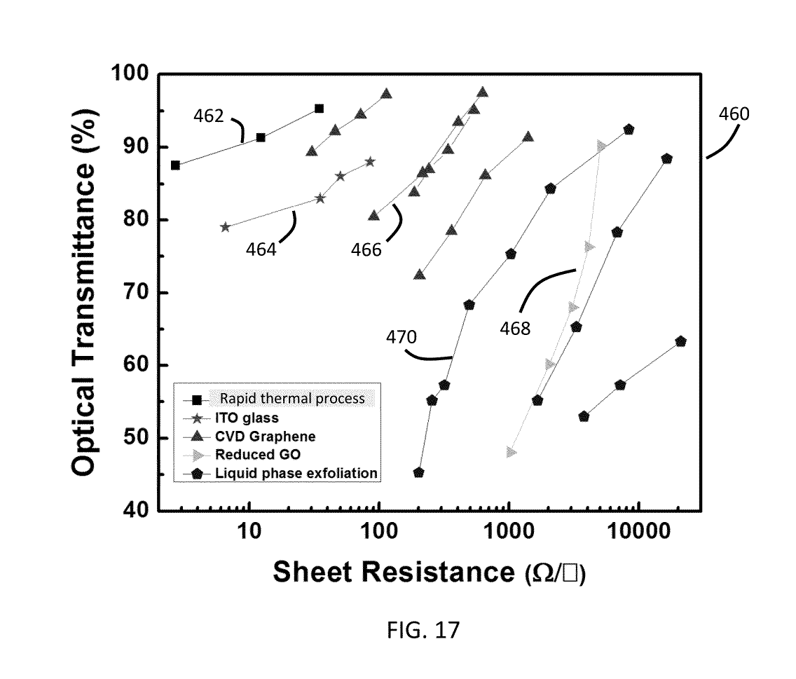

Referring to FIG. 17, a graph 460 shows the optical transmittance and sheet resistance of graphene samples produced using various methods, as well as ITO glass. The rapid thermal process graphene (represented by data points 462) has a high optical transmittance and a low sheet resistance, as compared to ITO glass (represented by data points 464), chemical vapor deposition graphene (represented by data points 466), reduced graphene oxide (represented by data points 468), and graphene produced using liquid phase exfoliation (represented by data points 470).

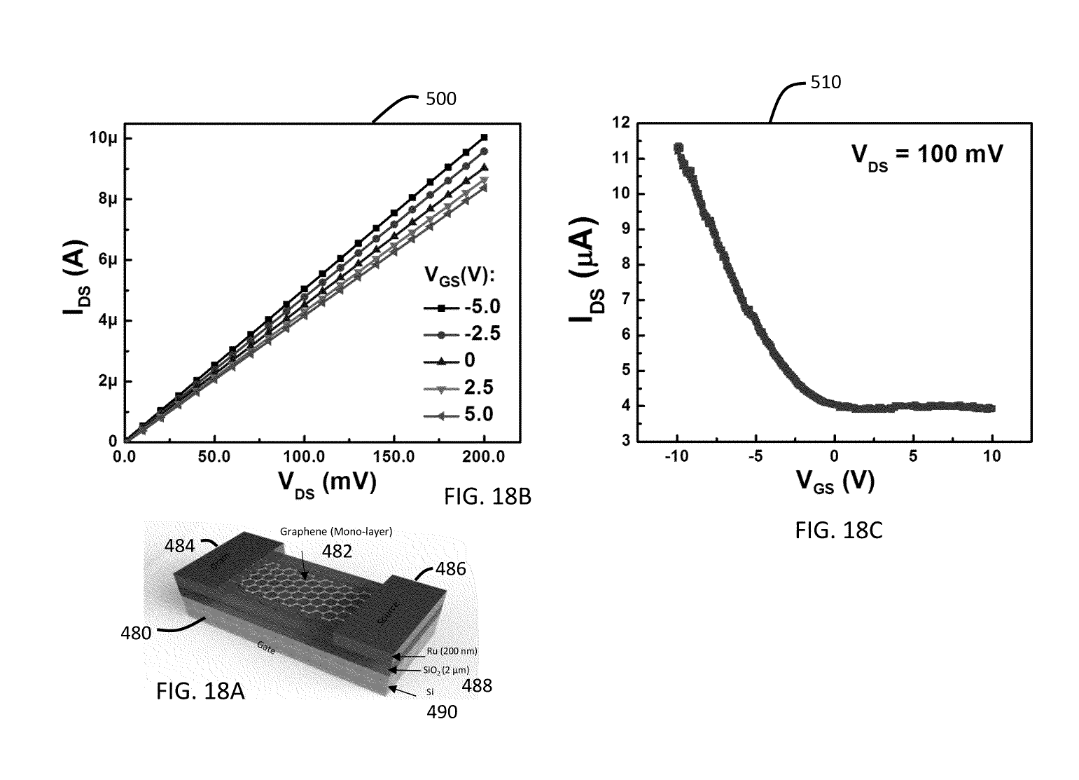

Referring to FIG. 18A, a graphene transistor can be fabricated by forming a thin ribbon of graphene 482 (e.g., mono-layer graphene) between a drain electrode 484 and a source electrode 486. The drain and source electrodes 484 and 486 can be made of ruthenium (Ru). The graphene 482, drain electrode 484, and source electrode 486 can be formed on a layer of silicon oxide 488, which is formed on a silicon substrate 490. The ruthenium drain and source electrodes can have a thickness of about 200 nm, and the silicon oxide layer 488 can have a thickness of about 2 μm.

Referring to FIG. 18B, a graph 500 shows relationships between drain-source current I_{DS} and drain-source voltage V_{DS}. The graph 500 indicates that for V_{GS} equal to −5.0, −2.5, 0, 2.5, and 5.0 volts, the drain-source current I_{DS} increases linearly with respect to the drain-source voltage V_{DS}.

Referring to FIG. 18C, a graph 510 shows the relationship between drain-source current I_{DS} and gate-source voltage V_{GS}. As the value of gate-source voltage V_{GS} decreases below zero, the drain-source current I_{DS} increases significantly as the gate-source voltage V_{GS} decreases. The drain source current I_{DS} remains relatively stable when the gate-source voltage V_{GS} increases above 0V. This indicates that the rapid thermal process graphene is P-type with a clear gate modulation effect.

The measurements of the graphene grown using the rapid thermal process, as shown in FIGS. 9 to 12 and 14 to 17, indicate that high-quality graphene can be produced on whole dielectric wafers using a single-step, transfer-free method. Uniform graphene sheets up to 4 inches in diameter have been obtained with a controlled number of layers by the single-step rapid thermal process method. In the examples described above, the sizes of the graphene sheets were limited by the rapid thermal process tube size. The graphene sheets can be made much larger if a larger rapid thermal process tube or oven is used. The formation of Ni₃C enables the autonomous evaporation of nickel at a temperature much lower than the nickel evaporation point. The autonomous nickel evaporation allows the direct formation of graphene on dielectric surfaces and prevents the formation of wrinkles in the graphene. As a result, high-quality graphene sheets have been obtained with a low sheet resistance of 50Ω/sq (a value close to the theoretical limit) and a high optical transmittance of 95.8% at 550 nm. Given the high scalability, simplicity, and fabrication compatibility, the transfer-free method has cleared the major barrier to the realization of graphene-based circuits and systems.

In the example shown in FIGS. 5 and 6, the graphene having comb-shaped pattern was produced by forming the comb-shaped pattern on the nickel layer using a photolithographic process, then applying the rapid thermal process to form the graphene. The following describes a way to produce graphene having specific patterns using a directing writing process.

In some implementations, arbitrary graphene patterns can be directly written onto dielectric substrates (e.g., glass, SiO₂/Si) using a light beam, such as a laser (either pulsed or continuous wave lasers), under ambient conditions. This method enables open-air fabrication of graphene patterns directly on dielectric substrates without a subsequent graphene transfer process.

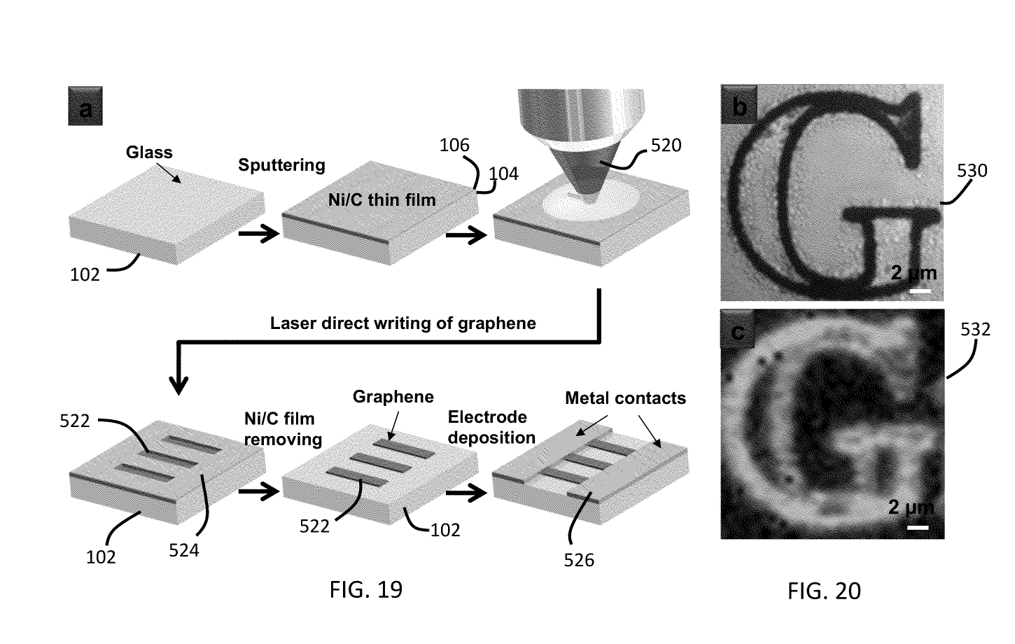

Referring to FIG. 19, in some implementations of a laser direct writing, a clean dielectric substrate 102 (e.g., glass, SiO₂/Si, quartz, or sapphire) is prepared, a carbon (e.g., amorphous carbon) thin film 104 is deposited on the substrate 102, and a nickel thin film 106 is deposited on the carbon thin film 104. The carbon and nickel thin films 104, 106 can be deposited using a direct current (DC) sputtering technique. A controlled laser direct writing (LDW) process is performed under ambient conditions using, e.g., a motorized-stage based or Galvo-mirror based laser direct writing system. In some examples, no vacuum and substrate heating are needed in the laser direct writing process.

During the laser direct writing process, a laser beam 520 is focused on the nickel/carbon thin films 104, 106 to induce localized heating to facilitate the growth of graphene. It is possible that the localized heating by the laser causes the carbon and the nickel to form metastable nickel carbide (Ni₃C), which decomposes to produce graphene. The laser beam 520 can have a variety of wavelengths, though it is preferable that the substrate is substantially transparent or at least partially transparent to the laser beam so that the substrate is not heated up by the laser beam. The graphene generated by the laser direct writing method can be, e.g., mono-layer graphene, bi-layer graphene, or multi-layer graphene. Similar to the examples in which the rapid thermal process is used to produce graphene, when the laser direct writing method is used to generate the graphene patterns, the ratio of the thicknesses of the carbon film and the nickel film affects whether mono-layer, bi-layer, or multi-layer graphene is produced.

By moving the sample stage with respect to the laser focal point, arbitrary patterns of graphene lines 522 can be formed directly on the dielectric substrate without using a graphene transfer process. It is also possible to use optical methods (e.g., Galvo-mirror(s)) to control the beam path of the laser beam so that the laser beam traverses across the substrate according to the desired pattern. After using laser direct writing to produce graphene patterns 522, the remaining nickel/carbon thin film 524 is removed by a wet chemical etching process, leaving only the graphene patterns 522 on the substrate 102. Graphene devices can be fabricated by additional deposition of metal contacts 526 over the graphene lines using conventional photolithography and lift-off processes.

In the example shown in FIG. 19, a layer of nickel is deposited on a layer of carbon. In some implementations, a layer of nickel is deposited on the substrate, then a layer of carbon is deposited on the layer of nickel. In some implementations, carbon and nickel are co-deposited in a single film on the substrate. The nickel can be replaced by other catalytic metal, such as cobalt or iron.

Referring to FIG. 20, an optical micrograph 530 and a Raman image 532 show graphene having the pattern of a letter “G” that was prepared using the laser direct writing process.

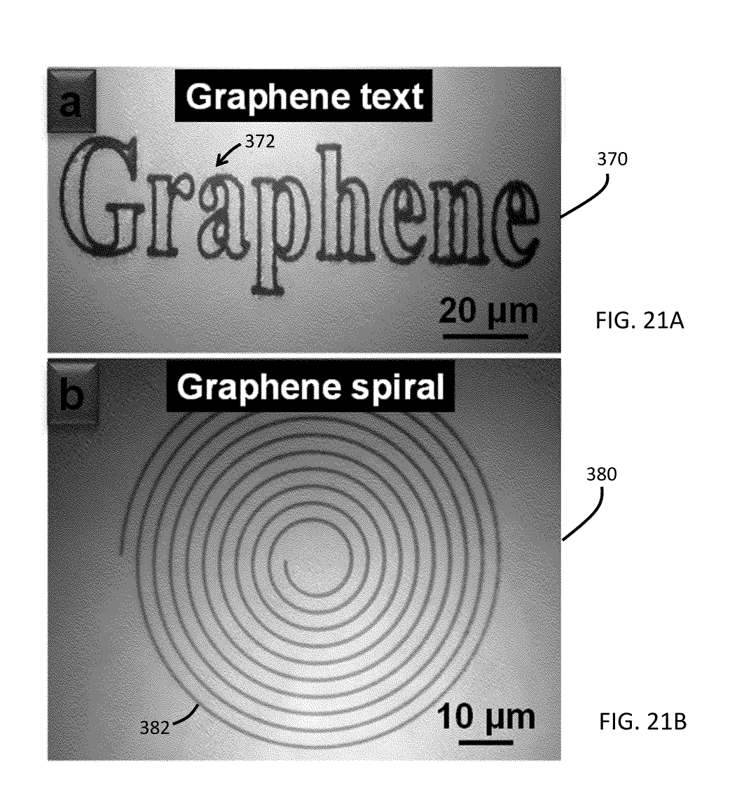

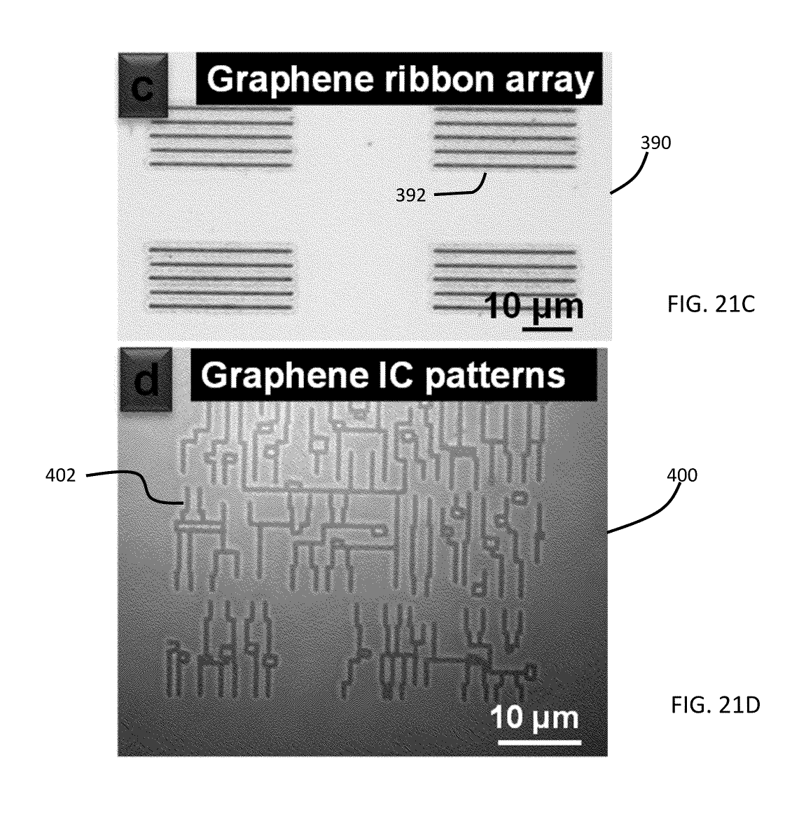

FIGS. 21A to 21D show images of arbitrary graphene patterns, including texts, spirals, parallel lines, and layouts of integrated circuits, that were produced using the laser direct writing method. Referring to FIG. 21A, an image 370 shows an optical micrograph of a “Graphene” text pattern 372 on a glass substrate. Referring to FIG. 21B, an image 380 shows an optical micrograph of a graphene spiral pattern 382 on a glass substrate. Referring to FIG. 21C, an image 390 shows an optical micrograph of graphene line arrays 392 on a SiO₂/Si substrate. Referring to FIG. 21D, an image 400 shows an optical micrograph of graphene integrated circuit patterns 402 on a glass substrate.

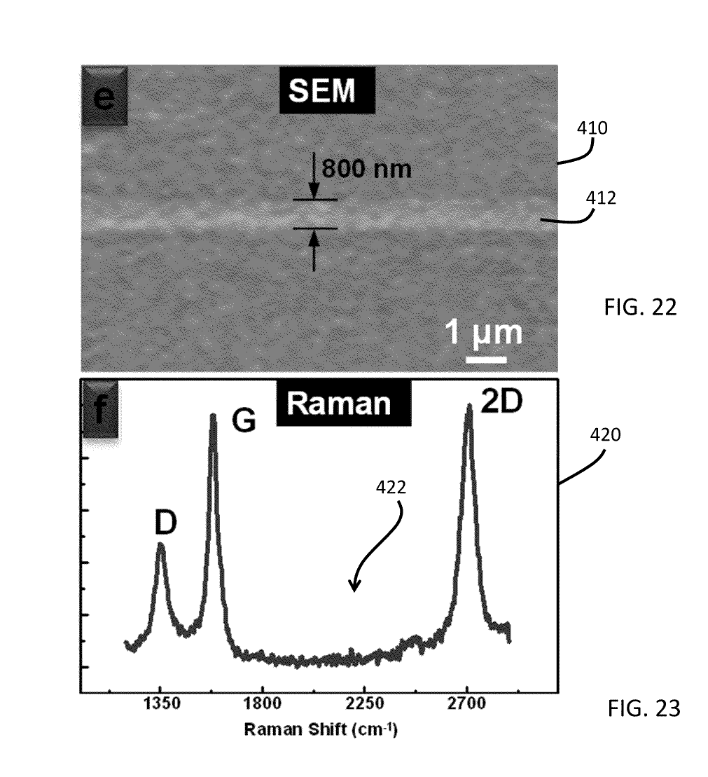

Referring to FIG. 22, a scanning electron microscope (SEM) micrograph 410 shows a graphene line 412 having a width of 800 nm. The graphene line was produced using the laser direct writing method. Referring to FIG. 23, a graph 420 shows a Raman spectrum 422 of the graphene lines produced using the laser direct writing method. The Raman characterization shows that the as-fabricated graphene patterns possess a high crystallinity and contain predominantly bi-layer graphene, which can be used in high-speed electronic applications.

The laser direct writing method has a number of advantages. The method is simple, scalable, and compatible to the existing infrastructures in industry. The fabrication of graphene only needs a DC sputtering and a two-dimensional laser scanning system, which are compatible to the infrastructures in industry. The cost of the laser direct writing method is low. Because open-air and room-temperature processing can be used, no costly chemical vapor deposition (CVD) chamber and graphene transfer steps are required in the graphene fabrication process. The process is safe because no explosive or toxic precursors, such as H₂ and CH₄ are required in the process. The graphene quality is high and has good crystallinity, conductivity and transparency.

The rapid thermal process (FIGS. 1 and 7) and the laser direct writing process (FIG. 19) can produce graphene on a dielectric substrate on which an electronic circuitry can be built. The graphene has good conductivity and can be used as conductors in the circuitry.

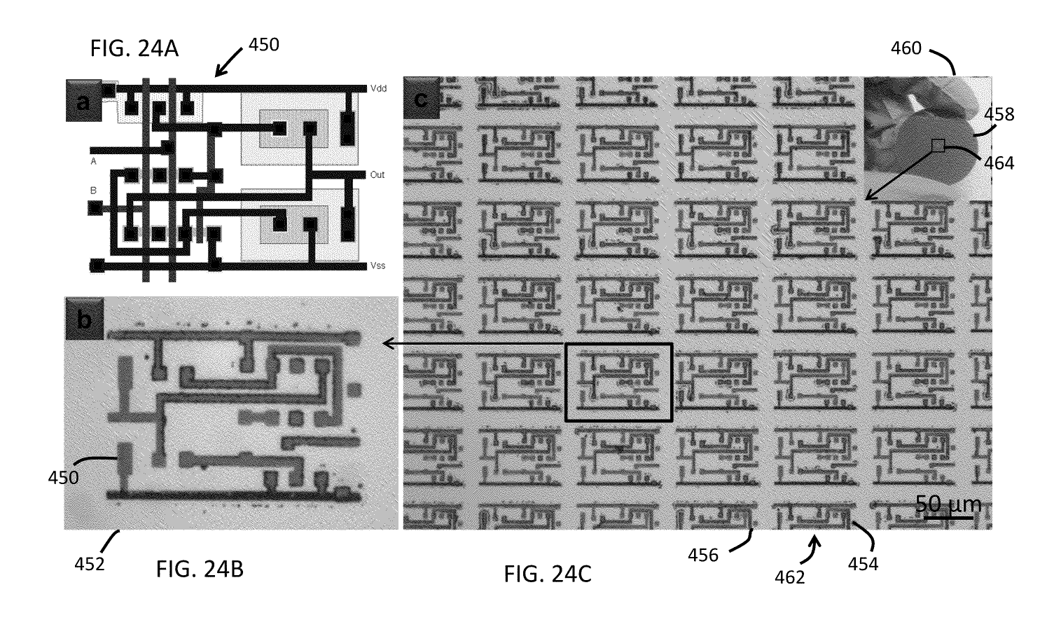

FIG. 24A is a diagram of a layout design 450 for an NAND circuit. FIG. 24B is an image 452 of graphene conductor lines 454 for the NAND circuit. FIG. 24C shows an image 460 of a wafer 458 and an image 462 showing an enlarged image of a region 464 of the wafer 458. The region 464 includes an array 462 of graphene conductor lines 454 for an array of NAND circuits.

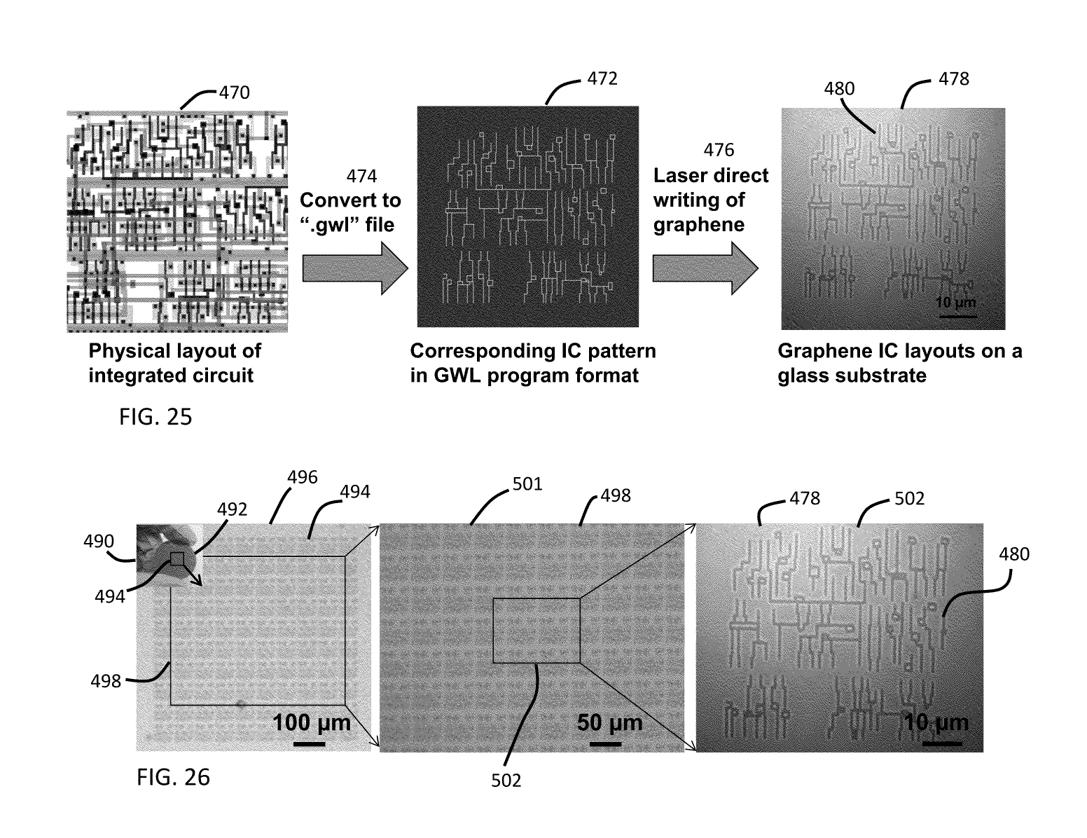

FIG. 25 shows a process for generating large-scale graphene-based integrated circuit patterns. A physical layer of an integrated circuit 470 is prepared. In some examples, the layout 470 is converted to a “.gwl” file (474). A diagram 472 shows the corresponding integrated circuit conductor line patterns in GWL program formal. The laser direct writing method can be used to generate graphene patterns that correspond to the integrated circuit conductor line patterns (476). An image 478 shows the graphene patterns 480 that were generated using the direct laser writing method.

FIG. 26 shows an image 490 of a wafer 492 on which an array of graphene patterns are formed using the laser direct writing method. An image 496 shows an enlarged image of a region 494 of the wafer 492. An image 501 shows an enlarged image of a region 498 within the region 494. An image 478 shows an enlarged image of a region 502 within the region 498. The region 502 includes the graphene patterns 480.

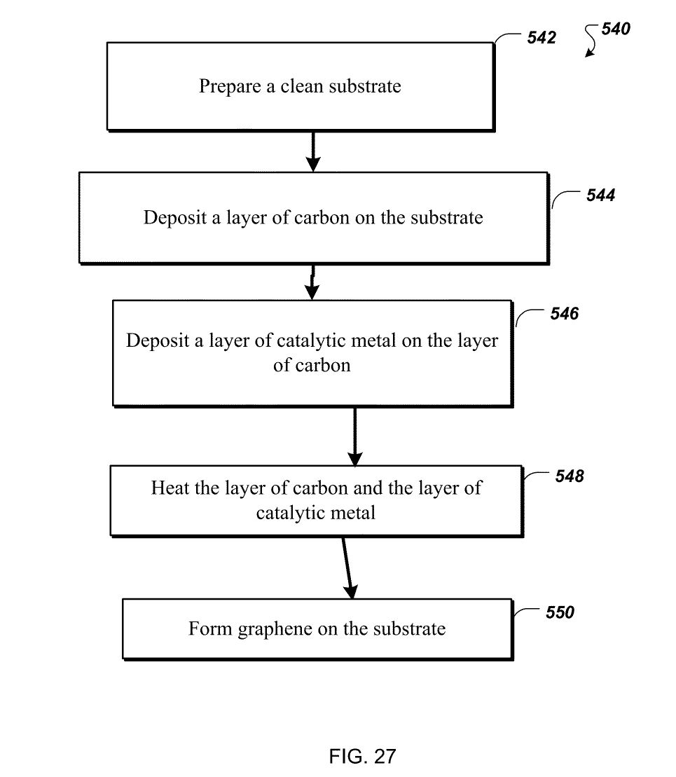

Referring to FIG. 27, a process 540 for fabricating graphene is provided. The process 540 includes preparing a clean substrate (542). For example, the substrate can be the substrate 102 of FIGS. 1 and 9, and can be, e.g., a SiO₂/Si, quartz, sapphire, or glass substrate. The substrate 102 can also be, e.g., a gold or copper substrate. A layer of carbon is deposited on the substrate (544). For example, the carbon layer can be the carbon layer 104. The carbon can be deposited using direct-current (DC) magnetron sputtering with graphite targets. The carbon can be amorphous carbon, and the carbon thin film can have a thickness in a range from, e.g., about 2 nm to 8 nm. A layer of catalytic metal is deposited on the layer of carbon (546). For example, the catalytic metal layer can be the nickel layer 106. The catalytic metal can also be, e.g., cobalt or iron. The catalytic metal can be deposited using the direct-current magnetron sputtering with catalytic metal targets. The layer of catalytic metal can have a thickness in a range from, e.g., about 50 nm to 95 nm.

The layer of carbon and the layer of catalytic metal are heated (548), e.g., using a rapid thermal process, resulting in the formation of graphene on the substrate (550). For example, the graphene can be the graphene 108. The graphene can be mono-layer graphene, bi-layer graphene, or multi-layer graphene that has three or more layers. During the rapid thermal process, carbon and catalytic metal thin films can be heated to a temperature in a range from about 900° C. to 1100° C. The rapid thermal process can have a duration of, e.g., less than five minutes, or about two minutes.

The catalytic metal/carbon thin film can be patterned before the rapid thermal process is applied, and the graphene will have the same pattern as the catalytic metal/carbon thin film. The graphene thin film can have a sheet resistance that is, e.g., less than 100 ohm/square, and a transmittance that is, e.g., greater than 90% for light having a wavelength in a range from 500 nm to 800 nm.

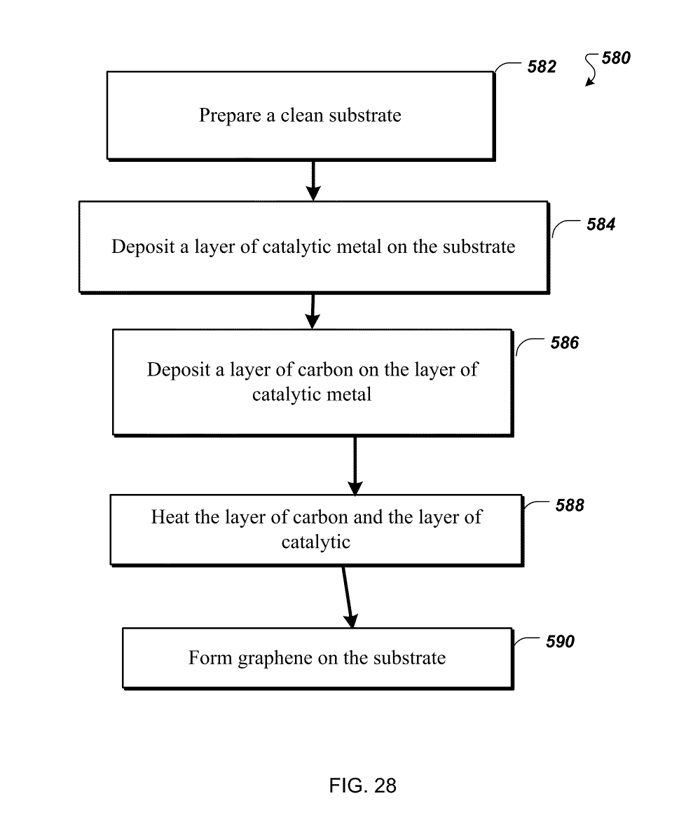

Referring to FIG. 28, a process 580 for fabricating graphene is provided. The process 580 includes preparing a clean substrate (582), depositing a layer of catalytic metal on the substrate (584), depositing a layer of carbon on the layer of catalytic metal (586), heating the layer of carbon and the layer of catalytic metal (588), and forming graphene on the substrate (590).

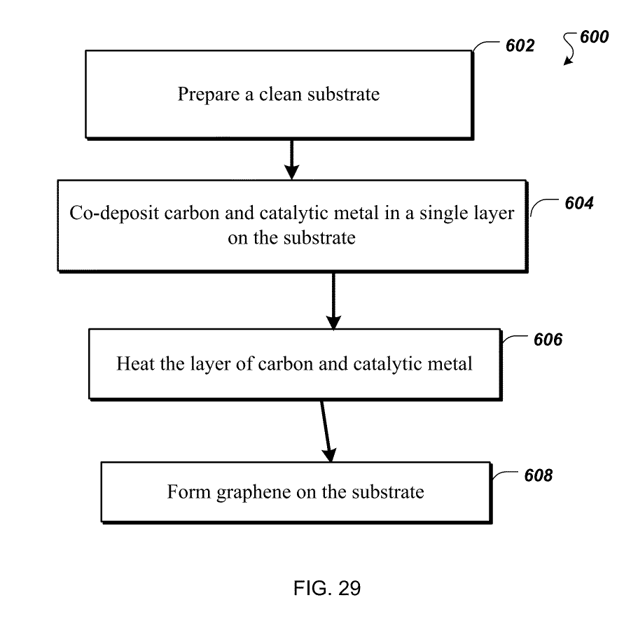

Referring to FIG. 29, a process 600 for fabricating graphene is provided. The process 600 includes preparing a clean substrate (602), co-depositing carbon and catalytic metal in a single layer on the substrate (604), heating the layer of carbon and catalytic metal (606), and forming graphene on the substrate (608).

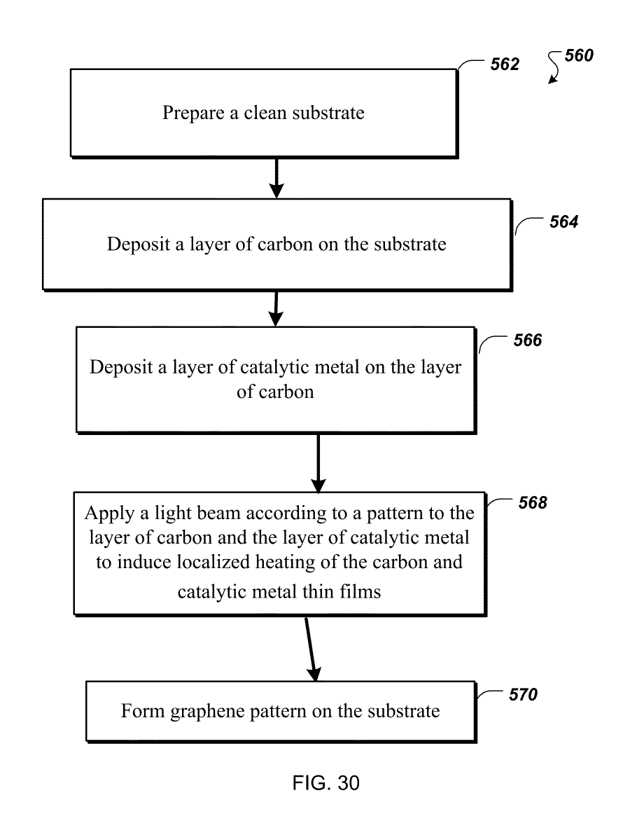

Referring to FIG. 30, a process 560 for fabricating graphene patterns is provided. The process 560 includes preparing a clean substrate (562). For example, the substrate can be the substrate 102 of FIGS. 1 and 9, and can be a SiO₂/Si, quartz, sapphire, or glass substrate. A layer of carbon is deposited on the substrate (564). For example, the carbon layer can be the carbon layer 104. The carbon can be deposited using direct-current (DC) magnetron sputtering with graphite targets. The carbon can be amorphous carbon, and the carbon thin film can have a thickness in a range from, e.g., about 2 nm to 8 nm. A layer of catalytic metal is deposited on the layer of carbon (566). For example, the catalytic metal layer can be the nickel layer 106. The catalytic metal can be deposited using the direct-current magnetron sputtering with catalytic metal targets. The layer of catalytic metal can have a thickness in a range from, e.g., about 50 nm to 95 nm.

A light beam is applied according to a pattern to the layer of carbon and the layer of catalytic metal, in which the light beam induces localized heating of the carbon and catalytic metal thin films (568). For example, the light beam can be the laser beam 520 of FIG. 21. The laser beam can be a pulsed laser beam or a continuous wave laser beam. A graphene pattern is formed on the substrate (570). For example, the graphene pattern can function as conducting lines in an electronic circuit.

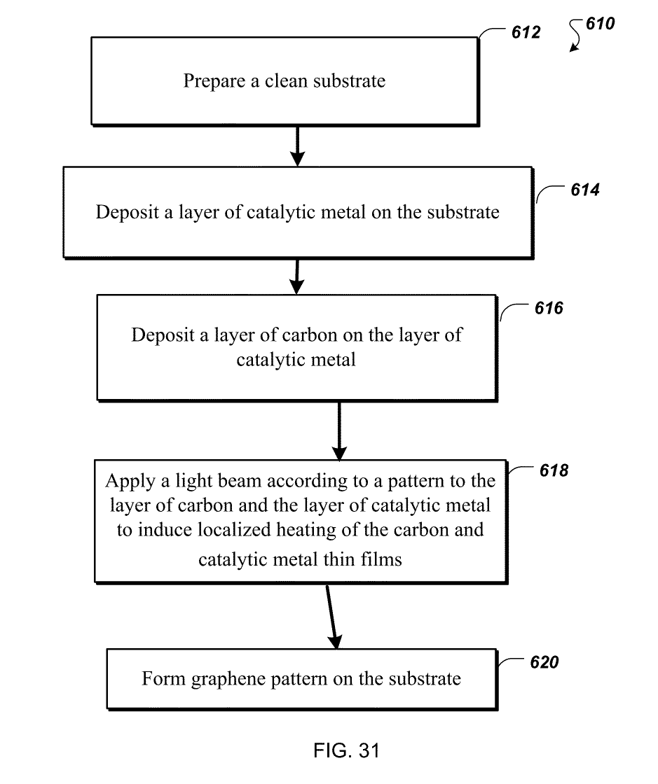

Referring to FIG. 31, a process 610 for fabricating graphene patterns is provided. The process 610 includes preparing a clean substrate (612), depositing a layer of catalytic metal on the substrate (614), depositing a layer of carbon on the layer of catalytic metal (616), applying a light beam according to a pattern to the layer of carbon and the layer of catalytic metal, in which the light beam induces localized heating of the carbon and catalytic metal thin films (618), and forming a graphene pattern on the substrate (620).

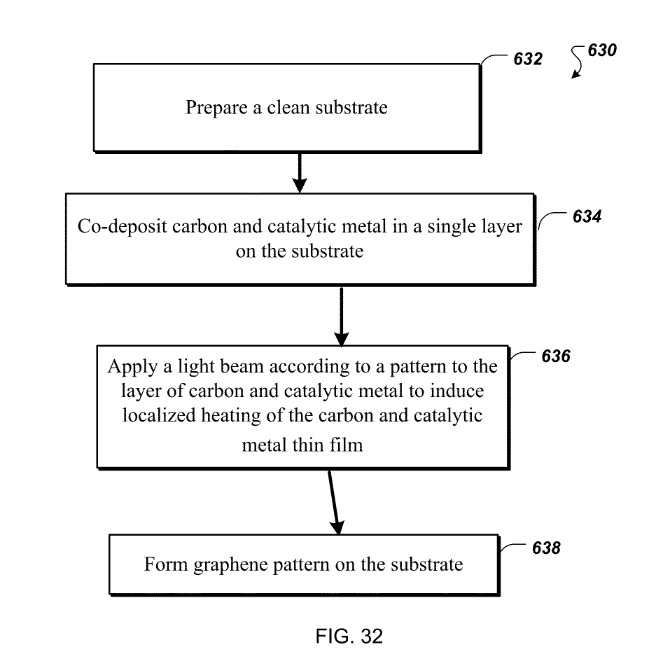

Referring to FIG. 32, a process 630 for fabricating graphene patterns is provided. The process 630 includes preparing a clean substrate (632), co-depositing carbon and catalytic metal in a single layer on the substrate (634), applying a light beam according to a pattern to the layer of carbon and catalytic metal, in which the light beam induces localized heating of the carbon and catalytic metal thin film (636), and forming a graphene pattern on the substrate (638).

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. Thus, although particular embodiments of the subject matter have been described, other embodiments are also within the scope of the following claims.

For example, the carbon film and the nickel film (or other catalytic metal film) can be deposited on the substrate using methods different from those described above. The thicknesses of the carbon film and the nickel film (or other catalytic metal film) can be different from those described above. The sizes on which the graphene is formed using the rapid thermal process or the laser direct writing method can be different from those described above.

What is claimed is:

1. A method comprising:
depositing carbon and catalytic metal on a substrate;
heating the carbon and the catalytic metal; and
forming graphene on the substrate.

2. The method of claim 1 in which depositing carbon and catalytic metal on a substrate comprises at least one of (1) depositing a layer of carbon on a substrate, and depositing a layer of catalytic metal on the layer of carbon, or (2) depositing a layer of catalytic metal on a substrate, and depositing a layer of carbon on the layer of catalytic metal.

3. The method of claim 1 in which depositing carbon and catalytic metal on a substrate comprises co-depositing carbon and catalytic metal in a single layer on a substrate.

4. The method of claim 1, comprising evaporating the catalytic metal while heating the carbon and the catalytic metal.

5. The method of claim 1 in which the catalytic metal comprises at least one of nickel, cobalt, or iron.

6. The method of claim 2 in which the layer of carbon has a thickness in a range from about 1 nm to 100 nm.

7. The method of claim 2 in which the layer of catalytic metal has a thickness in a range from about 1 nm to 1000 nm.

8. The method of claim 1 in which forming graphene comprises forming mono-layer graphene on the substrate.

9. The method of claim 1 in which forming graphene comprises forming bi-layer graphene on the substrate.

10. The method of claim 1 in which depositing carbon on a substrate comprises depositing amorphous carbon on a substrate.

11. The method of claim 1 in which forming graphene comprises forming few-layer graphene on the substrate in which the few-layer graphene comprises three or more layers of graphene.

12. The method of claim 1 in which heating the carbon and the catalytic metal comprises applying a rapid heating process to the carbon and the catalytic metal.

13. The method of claim 1, comprising patterning the catalytic metal before heating the carbon and the catalytic metal.

14. The method of claim 13 in which forming graphene on the substrate comprises forming graphene having a pattern that is the same as the pattern of the catalytic metal.

15. The method of claim 14, comprising forming metal contacts on the patterned graphene.

16. The method of claim 15, comprising forming electronic components coupled to the metal contacts.

17. The method of claim 13 in which patterning the catalytic metal comprises removing a portion of the catalytic metal.

18. The method of claim 1 in which heating the carbon and the catalytic metal comprises heating the carbon and the catalytic metal in a vacuum chamber.

19. The method of claim 1 in which heating the carbon and the catalytic metal comprises using a flashlamp to heat the carbon and the catalytic metal.

20. The method of claim 1 in which heating the carbon and the catalytic metal comprises heating the carbon and the catalytic metal in a protection environment.

21. The method of claim 1 in which heating the carbon and catalytic metal comprises applying a light beam to heat the carbon and catalytic metal.

22. The method of claim 21 in which applying a light beam to heat the carbon and catalytic metal comprises applying a laser beam to heat the carbon and catalytic metal.

23. The method of claim 21 in which applying a light beam to heat the carbon and catalytic metal comprises applying a flash lamp to heat the carbon and catalytic metal.

24. The method of claim 1 in which depositing carbon and catalytic metal on a substrate comprises depositing carbon and catalytic metal on a substrate that does not interact with the carbon and the catalytic metal.

25. The method of claim 24 in which the substrate comprises at least one of silicon oxide/silicon, sapphire, quartz, or glass substrate.

26. The method of claim 24 in which the substrate comprises at least one gold or copper substrate.

27. The method of claim 1 in which depositing catalytic metal comprises using a thin film deposition process to deposit the catalytic metal.

28. The method of claim 27 in which the thin film deposition process comprises DC sputtering.

29. The method of claim 1, comprising fabricating an electronic device using the graphene as a transparent conductor.

30. The method of claim 29 in which fabricating an electronic device comprises fabricating a display using the graphene as a transparent conductor.

31. A method comprising:
depositing carbon and catalytic metal on a substrate;
applying a light beam to the carbon and the catalytic metal, the light beam to induce localized heating of the carbon and the catalytic metal; and
forming graphene on the substrate at locations where the carbon and catalytic metal have been illuminated by the light beam.

32. The method of claim 31 in which depositing carbon and catalytic metal on a substrate comprises at least one of (1) depositing a layer of carbon on a substrate, and depositing a layer of catalytic metal on the layer of carbon, or (2) depositing a layer of catalytic metal on a substrate, and depositing a layer of carbon on the layer of catalytic metal.

33. The method of claim 31 in which depositing carbon and catalytic metal on a substrate comprises co-depositing carbon and catalytic metal in a single layer on a substrate.

34. The method of claim 31, comprising evaporating the catalytic metal while heating the carbon and the catalytic metal with the light beam.

35. The method of claim 31 in which applying a light beam to the carbon and the catalytic metal comprises applying a laser beam to the carbon and the catalytic metal.

36. The method of claim 35 in which applying a laser beam to the carbon and the catalytic metal comprises applying at least one of a continuous wave or a pulsed laser beam to the carbon and the catalytic metal.

37. The method of claim 31 in which applying a light beam to the carbon and the catalytic metal comprises applying a light beam to write a pattern on the catalytic metal and the carbon, and forming graphene on the substrate comprises forming graphene having the pattern written by the light beam.

38. The method of claim 37 in which applying a light beam to write a pattern on the catalytic metal and carbon comprises applying a light beam to write a pattern that correspond to conducting lines of an electronic circuit, and forming graphene on the substrate comprises forming graphene having the pattern that correspond to conducting lines of an electronic circuit.

39. The method of claim 32 in which the layer of carbon has a thickness in a range from about 1 nm to 100 nm.

40. The method of claim 32 in which the layer of catalytic metal has a thickness in a range from about 1 nm to 1000 nm.

41. The method of claim 31 in which forming graphene comprises forming mono-layer graphene on the substrate.

42. The method of claim 31 in which forming graphene comprises forming bi-layer graphene on the substrate.

43. The method of claim 31, comprising removing a portion of the catalytic metal that has not been illuminated by the light beam.

44. The method of claim 31 in which depositing carbon on a substrate comprises depositing amorphous carbon on a substrate.

45. The method of claim 31 in which forming graphene comprises forming few-layer graphene on the substrate in which the few-layer graphene comprises three or more layers of graphene.

46. The method of claim 31 in which depositing carbon and catalytic metal on a substrate comprises depositing carbon and catalytic metal on a substrate that does not interact with the carbon and the catalytic metal.

47. The method of claim 46 in which the substrate comprises at least one of silicon oxide/silicon, sapphire, quartz, or glass substrate.

48. The method of claim 46 in which the substrate comprises at least one of gold or copper substrate.

49. The method of claim 31 in which depositing catalytic metal comprises using a thin film deposition process to deposit the catalytic metal.

50. The method of claim 49 in which the thin film deposition process comprises DC sputtering.

51. The method of claim 38, comprising fabricating an electronic device using the patterned graphene as a transparent conductor.

52. The method of claim 51 in which fabricating an electronic device comprises fabricating a display using the patterned graphene as a transparent conductor.
